(19) United States
(12) Patent Application Publication
(10) Pub. No.: US 2017/0154296 A1
(43) Pub. Date: Jun. 1, 2017

(54) PRIORITIZING CONTEXTUAL INFORMATION SYSTEM, METHOD, AND RECORDING MEDIUM

(71) Applicant: International Business Machines Corporation, Armonk, NY (US)

(72) Inventors: Shang Qing Guo, Cortlandt Manor, NY (US); Jonathan Lenchner, North Salem, NY (US); Maharaj Mukherjee, Poughkeepsie, NY (US)

(21) Appl. No.: 14/955,855

(22) Filed: Dec. 1, 2015

(51) Int. Cl. G06Q 10/06

(52) U.S. Cl. CPC G06Q 10/063112

(57) ABSTRACT

A prioritizing contextual information method, system, and non-transitory computer readable medium including dividing users into one or more groups, each group being associated with a task to be completed based on roles and skills of each of the one or more users, dividing data into one or more data sets based on the skills needed to use the data in the data sets and the roles of users needed for the data, and matching a data set of the one or more data sets to a group of the one or more groups based on the roles and skills associated with the data set and the group.

### BACKGROUND

The present invention relates generally to a prioritizing contextual information system, and more particularly, but not by way of limitation, to a prioritizing contextual information system whereby the information that is relevant for a particular individual is prioritized based on the context and arranged in an order according to a priority and an ease of understanding and browsing.

Conventionally, in team-style work settings, people often belong to many social, family and professional groups, or different working groups that they interact with at their job. The groups are dynamic and often change their composition. People often have to keep track of many different types of information such as charts, spreadsheets, project plans, social network blogs, emails, message boards that contain information associated with each group that they belong to, etc. When someone leaves a team, that member may leave a lot of information that is not properly tagged or marked and may be in a very disorganized and unstructured form. Conversely, when someone joins a group that has been functioning for some time, they need to quickly come up to speed by getting familiar with all the different forms of information created and previously generated by the group.

Conventional techniques to manage a dynamic group generate a role-based user interface to be presented to a user that includes processing a security-relevant portion of user interface code associated with an application, determining a permission by processing application role information pertaining to the user and security policy information. However, such techniques do not address the problem of how information can be shared based on roles or expertise.

Thus, there is a technical problem in the conventional techniques that the techniques do not consider how to effectively share information among members of a group and how information can be shared based on roles or expertise of the users of a team.

### SUMMARY

In an exemplary embodiment, the present invention can provide a prioritizing contextual information method, including dividing users into one or more groups, each group being associated with a task to be completed based on roles and skills of each of the one or more users, dividing data into one or more data sets based on the skills needed to use the data in the data sets and the roles of users needed for the data, and matching a data set of the one or more data sets to a group of the one or more groups based on the roles and skills associated with the data set and the group.

Further, in another exemplary embodiment, the present invention can provide a prioritizing contextual information system, including a group dividing device configured to divide users into one or more groups, each group being associated with a task to be completed based on roles and skills of each of the one or more users, a data dividing device configured to divide data into one or more data sets based on the skills needed to use the data in the data sets and the roles of users needed for the data, and a matching device configured to match a data set of the one or more data sets to a group of the one or more groups based on the roles and skills associated with the data set and the group.

Even further, in another exemplary embodiment, the present invention can provide a non-transitory computer-readable recording medium recording a prioritizing contextual information program, the program causing a computer to perform: dividing users into one or more groups, each group being associated with a task to be completed based on roles and skills of each of the one or more users, dividing data into one or more data sets based on the skills needed to use the data in the data sets and the roles of users needed for the data, and matching a data set of the one or more data sets to a group of the one or more groups based on the roles and skills associated with the data set and the group.

There has thus been outlined, rather broadly, an embodiment of the invention in order that the detailed description thereof herein may be better understood, and in order that the present contribution to the art may be better appreciated. There are, of course, additional exemplary embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The exemplary aspects of the invention will be better understood from the following detailed description of the exemplary embodiments of the invention with reference to the drawings.

FIG. 1 exemplarily shows a block diagram illustrating a configuration of a prioritizing contextual information system 100.

FIG. 2 exemplarily shows a high level flow chart 200 for a prioritizing contextual information method.

FIG. 3 depicts a cloud computing node according to an embodiment of the present invention.

FIG. 4 depicts a cloud computing environment according to another embodiment of the present invention.

FIG. 5 depicts abstraction model layers according to an embodiment of the present invention.

### DETAILED DESCRIPTION

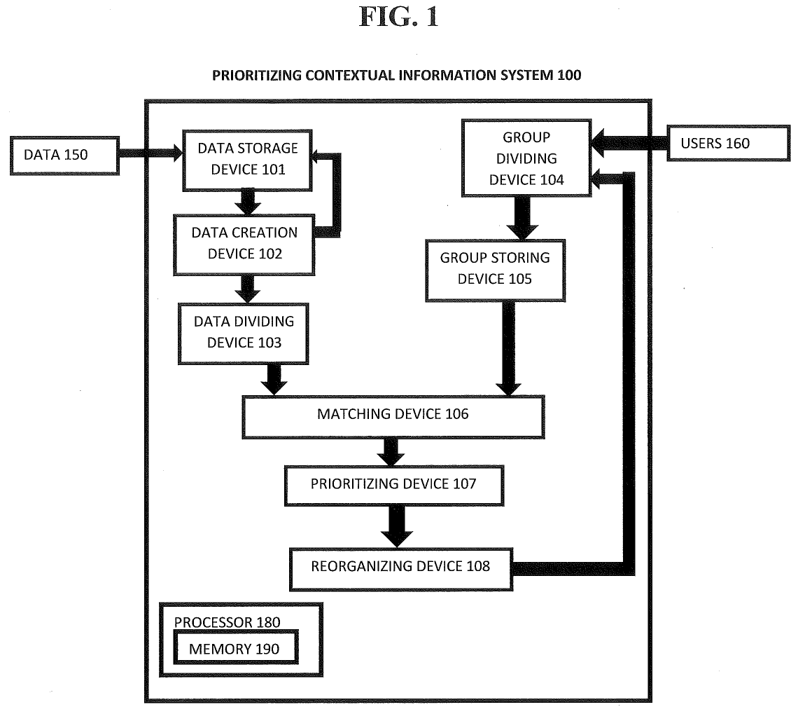

The invention will now be described with reference to FIGS. 1-5, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims.

With reference now to FIG. 1, the prioritizing contextual information system 100 includes a data storage device 101, a data creation device 102, a data dividing device 103, a group dividing device 104, a group storing device 105, a matching device 106, a prioritizing device 107, and a reorganizing device 108. The prioritizing contextual information system 100 includes a processor 180 and a memory 190, with the memory 190 storing instructions to cause the processor 180 to execute each device of prioritizing contextual information system 100.

Although the prioritizing contextual information system 100 includes various devices, it should be noted that a prioritizing contextual information system can include modules in which the memory 190 stores instructions to cause the processor 180 to execute each module of prioritizing contextual information system 100.

With the use of these various devices, the prioritizing contextual information system 100 may act in a more sophisticated and useful fashion, and in a cognitive manner while giving the impression of mental abilities and processes related to knowledge, attention, memory, judgment and evaluation, reasoning, and advanced computation. That is, a system is said to be “cognitive” if it possesses macro-scale properties—perception, goal-oriented behavior, learning/memory and action—that characterize systems (i.e., humans) that all agree are cognitive.

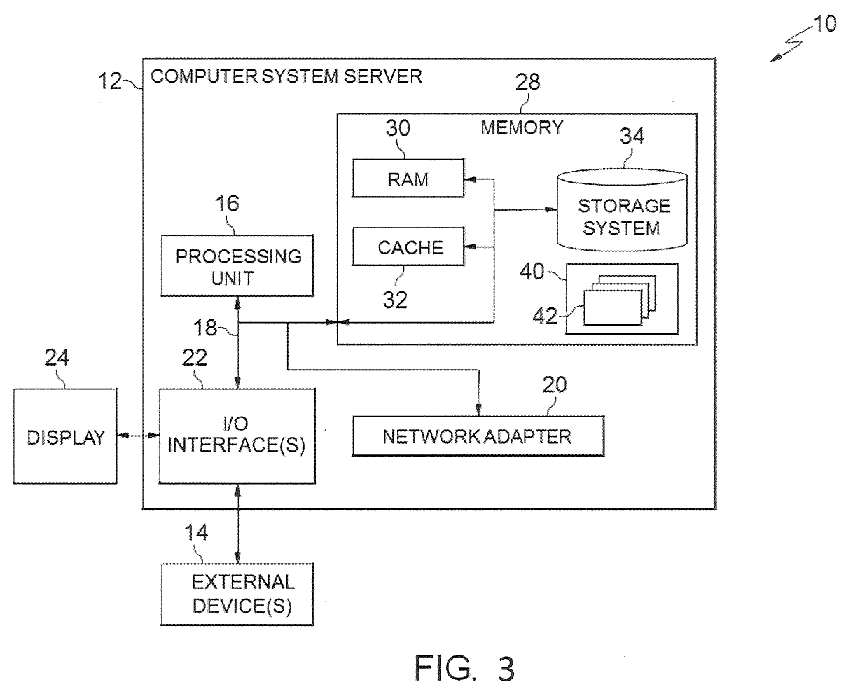

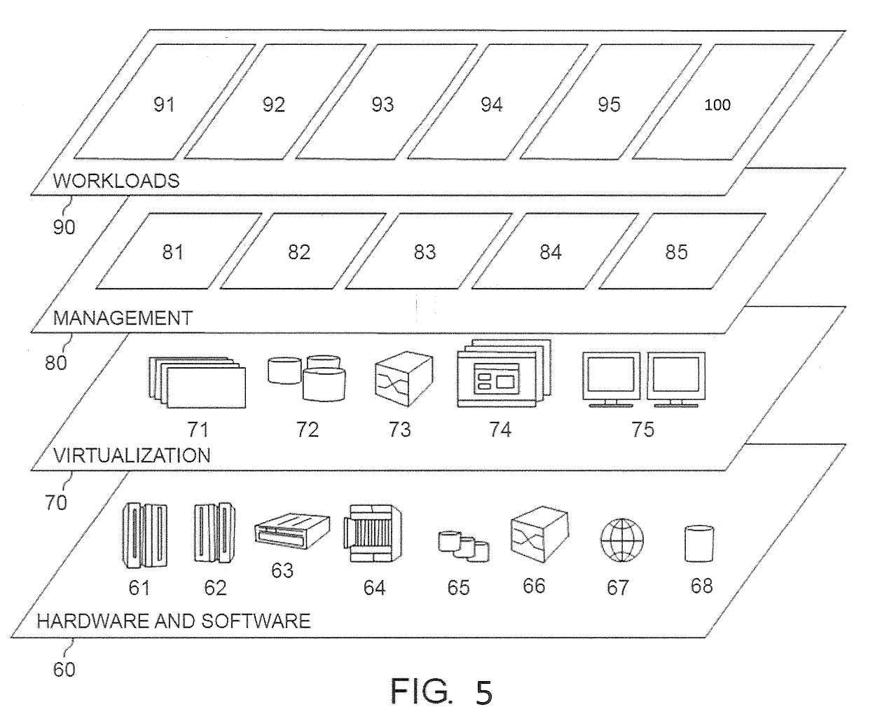

Although as shown in FIGS. 3-5 and as described later, the computer system/server 12 is exemplarily shown in cloud computing node 10 as a general-purpose computing device which may execute in a layer the prioritizing contextual information system 100 (FIG. 5), it is noted that the present invention can be implemented outside of the cloud environment.

The data storage device 101 receives data 150. The data 150 can include initial documents for a group to complete a task. Further, the data can include, but not limited to, charts, spreadsheets, project plans, social network blogs, emails, message boards containing information associated with the group, any information pertaining to the group tasks, etc. Also, the data 150 can include raw data that the formed group needs to complete their task. The data 150 can pertain to a group's mission, objectives and tasks and can be derived via mining a group's emails, created documents, prior read articles on the web, etc.

The data creation device 102 creates additional data over time either based on the initial data 150 received or on new tasks from the group, and loops the additional data to be stored in the data storage device 101. The additional data can be created via mining data created by the group's activities. For example, the additional data can be derived via mining a group's emails, created documents, prior read articles on the web, etc.

The data dividing device 103 divides the data 150 into data sets based on the skill needed to use the data and the roles of users 160 in a group needed for the data 150. For example, if the data 150 includes a debugging script, the data dividing device 103 will sort the data 150 including the debugging script to a debugger in a group. Also, the data dividing device 103 will determine the skill level needed by a debugger in the group in order to use the debugging script and associate the debugging script with a given skill level. That is, if the debugging script requires the expert on the team, the data dividing device 103 will label the debugging script to include a marker indicating that the data requires an expert to complete.

The group dividing device 104 receives the users 160 (i.e., people) that are to be assigned to the group to complete the task.

Users 160 can participate in different groups, and can even belong to a subgroup of a larger group. The users 160 have different roles and different level of familiarities with the group's objective and missions and references regarding how the users 160 receive and respond to different kinds of information. A user's 160 expertise and role is input into the group dividing device 104 via monitoring the users' 160 background with respect to the group's mission, objectives and task.

The group dividing device 104 divides the users 160 into groups to complete the tasks based on roles and skills of each of the users 160. For example, the group dividing device 104 will divide all debuggers together, all programmers together, all graphical designers together, etc. Then, the group dividing device 104 sets the users 160 in the groups with their skill level for each of the tasks. That is, the group dividing device 104 divides the group and associates context and key words with the tasks for the user.

Also, the group dividing device 104 will divide new users 160 assigned to the group into an existing group based on their skill level and role. In this manner, the groups can be dynamically managed as group members enter or leave the group.

It should be noted that the group dividing device 104 sets the users 160 within a particular role with a skill level, but the group dividing device 104 also labels the users 160 with each of their available skills.

The group storing device 105 stores the groups output by the group dividing device 104.

The matching device 106 matches the data 150 divided into particular skill and roles by the data dividing device 103 with the users 160 divided into particular roles and skills by the group dividing device 104.

For example, the matching device 106 recognizes important information for a particular group. Then the matching device 106 categorizes the information based on the roles as well as familiarity levels to assign tasks to group members. The matching device 106 recognizes a user's 160 role within each group it participates by using the context and key words associated with the tasks for the user.

In other words, the matching device 106 correlates the skill and role of the data 150 to a group of users who match the skill and role needed to use the data 150 to complete a task.

For example, if data 160 was divided to be required to be completed by an expert debugger by the data dividing device 103 and the group dividing device 104 divides the users 160 into a group of users which have a debugging role and an expert skill level, the matching device 106 matches the data 160 for the expert debugging task with the expert debugger.

The prioritizing device 107 changes the matching by the matching device 106 based on a real-time change in individual skill. That is, the prioritizing device 107 has a cognitive determination of the users 160 changing skill level in the group and prioritizes which data 150 goes to which user 160. That is, the priority of data may be altered as situations changes for a project and as objectives and missions are reprioritized.

Further, some data 150 may be time-sensitive with the information's relevance diminishing significantly over time. The prioritizing device 107 learns to categorize such data 150 and puts them in the proper priority of ordering.

The reorganizing device 108 reorganizes the groups based on updated skill sets of the users 160 in the group. That is, if a user learns additional tasks during the project relating to a different expertise, the reorganizing device 108 will label that user as being capable of being part of multiple groups. In this sense, the prioritizing contextual information system 100 dynamically updates the capabilities of the users 160 based on their past experiences so as to optimize the efficiency of the groups.

Further, the reorganizing device 108 can reorganize users 160 based on their past performance. For example, if a specific user takes longer to learn a task, the user 160 will be reorganized in the group so as not to be associated with time-sensitive tasks since the user cannot quickly learn.

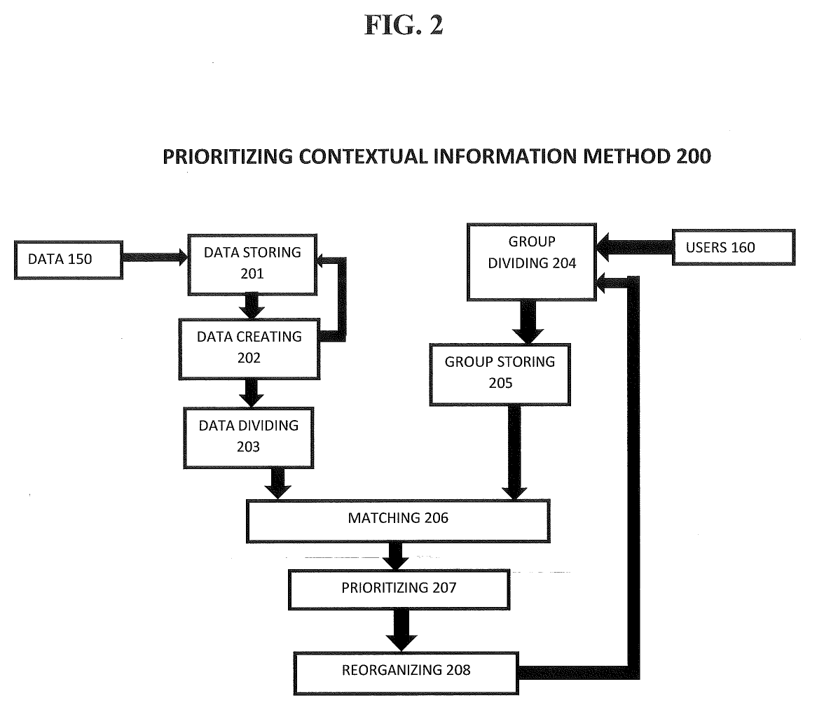

FIG. 2 shows a high level flow chart for a method 200 for a prioritizing contextual information method.

Step 201 receives data 150 that pertains to a group's mission, objectives and tasks and can be derived via mining a group's emails, created documents, prior read articles on the web, etc.

Step 202 creates additional data over time and loops the additional data to Step 201 to be combined with the received data 150.

Step 203 divides the data 150 into data sets based on the skill needed to use the data and the roles of users 160 in a group needed for the data 150.

Step 204 receives users 160 and divides the users 160 into groups to complete the tasks based on roles and skills of each of the users 160. That is, Step 204 divides the group and associates context and key words with the tasks for the user.

Step 205 stores the divided groups divided by Step 204.

Step 206 matches the data 150 divided into particular skill and roles by the data dividing Step 203 with the users 160 divided into particular roles and skills by the group dividing Step 204.

Step 207 prioritizes the matching by changing the matching based on a real-time change in individual skill. That is, the prioritizing Step 207 has a cognitive determination of the users 160 changing skill level in the group and prioritizes which data 150 goes to which user 160. The prioritizing further suggests an order in which data 150 should be distributed to users 160 of the group be read to optimize reading efficiency, given the accepted metrics for the whole group. Also, the prioritizing can estimate learning and coming up to speed time of a user based on a historical learning pattern of such reading times for similar media.

Step 208 reorganizes the groups based on updated skill sets of the users 160 in the group such that the group dividing Step 204 can divide the group based on updated parameters.

Exemplary Hardware Aspects, Using a Cloud Computing Environment

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 3, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

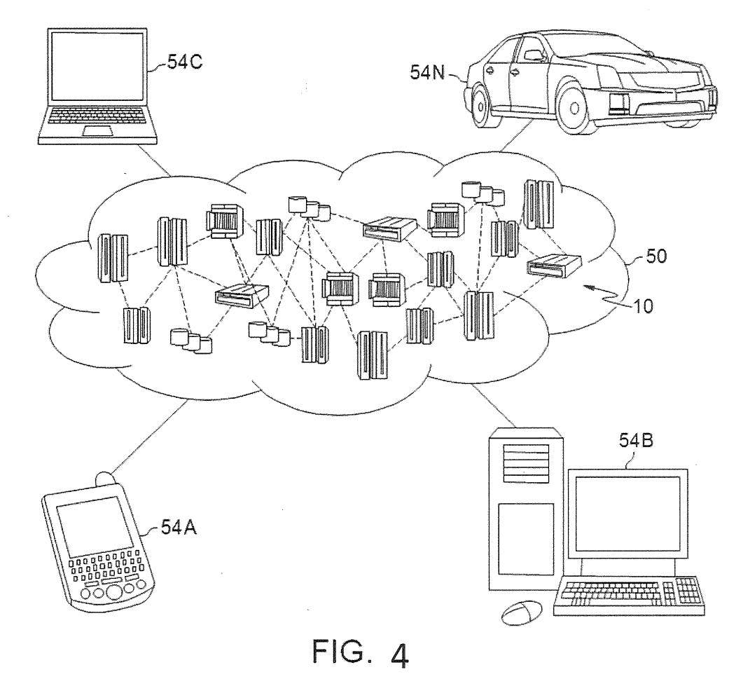

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the prioritizing contextual information system 100 described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A prioritizing contextual information method, comprising:
dividing users into one or more groups, each group being associated with a task to be completed based on roles and skills of each of the users;
dividing data into one or more data sets based on the skills needed to use the data in the data sets and the roles of users needed for the data; and
matching a data set of the one or more data sets to a group of the one or more groups based on the roles and skills associated with the data set and the group.

2. The method of claim 1, further comprising prioritizing the matching by modifying the matching based on a real-time change in a skill of an individual user within the group.

3. The method of claim 1, further comprising prioritizing the matching via a cognitive determination of a current skill level of a user in the group and prioritizing which data to match to the user based on the current skill level as compared to a previous skill level.

4. The method of claim 1, further comprising reorganizing users of the groups based on a current skill level of the users in the group such that the dividing divides the group based on the current skill level.

5. The method of claim 2, wherein the prioritizing further suggests an order in which data should be distributed to users of the group.

6. The method of claim 2, wherein the prioritizing further estimates learning patterns of each user in the groups based on a historical learning pattern for each user based on similar data.

7. The method of claim 2, wherein the prioritizing further recognizes and learns preferences and interests of the group of users, and prioritizes data to a particular user based on the preferences and the interests of the group of users.

8. The method of claim 1, further comprising creating data for a group's mission via mining data created by the group's activities.

9. The method of claim 1, further comprising reorganizing the users of a group based on an updated skill set and an updated role of the users within the group.

10. The method of claim 1, wherein the dividing associates context and key words with a task for the users after the dividing the users into groups.

11. A prioritizing contextual information system, comprising:
a group dividing device configured to divide users into one or more groups, each group being associated with a task to be completed based on roles and skills of each of the users;
a data dividing device configured to divide data into one or more data sets based on the skills needed to use the data in the data sets and the roles of users needed for the data; and
a matching device configured to match a data set of the one or more data sets to a group of the one or more groups based on the roles and skills associated with the data set and the group.

12. The system of claim 11, further comprising a prioritizing device configured to prioritize the matching of the matching device by modifying the matching based on a real-time change in a skill of an individual user within the group.

13. The system of claim 11, further comprising a prioritizing device configured to prioritize the matching of the matching device via a cognitive determination of a current skill level of a user in the group and prioritizing which data to match to the user based on the current skill level as compared to a previous skill level.

14. The system of claim 11, further comprising a reorganizing device configured to reorganize users of the groups based on a current skill level of the users in the group such that the group dividing device divides the group based on the current skill level.

15. The system of claim 12, wherein the prioritizing device further suggests an order in which data should be distributed to users of the group.

16. A non-transitory computer-readable recording medium recording a prioritizing contextual information program, the program causing a computer to perform:
dividing users into one or more groups, each group being associated with a task to be completed based on roles and skills of each of the users;
dividing data into one or more data sets based on the skills needed to use the data in the data sets and the roles of users needed for the data; and
matching a data set of the one or more data sets to a group of the one or more groups based on the roles and skills associated with the data set and the group.

17. The non-transitory computer-readable recording medium of claim 16, further comprising prioritizing the matching by modifying the matching based on a real-time change in a skill of an individual user within the group.

18. The non-transitory computer-readable recording medium of claim 16, further comprising prioritizing the matching via a cognitive determination of a current skill level of a user in the group and prioritizing which data to match to the user based on the current skill level as compared to a previous skill level.

19. The non-transitory computer-readable recording medium of claim 16, further comprising reorganizing users of the groups based on a current skill level of the users in the group such that the dividing divides the group based on the current skill level.

20. The non-transitory computer-readable recording medium of claim 17, wherein the prioritizing further suggests an order in which data should be distributed to users of the group.
